(19) United States
(12) Patent Application Publication
(10) Pub. No.: US 2013/0115880 A1
(43) Pub. Date: May 9, 2013

(54) Pairing a Bluetooth Device to a Virtual Desktop in a Hosted Desktop Environment

(71) Applicants: Brian Dal Bello, Allen, TX (US); Joseph Enda Smyth, Galway (IE); Liam Patrick O'Gorman, Co. Limerick (IE)

(72) Inventors: Brian Dal Bello, Allen, TX (US); Joseph Enda Smyth, Galway (IE); Liam Patrick O'Gorman, Co. Limerick (IE)

(73) Assignee: CISCO TECHNOLOGY, INC., San Jose, CA (US)

(21) Appl. No.: 13/292,164

(22) Filed: Nov. 9, 2011

(51) Int. Cl. H04B 7/00

(52) U.S. Cl. 455/41.2

(57) ABSTRACT

Techniques are provided for a client to send a message to a server comprising information configured to indicate that a user has logged on to the client. A determination is made as to whether the user logging on for the first time. When the user logs on for the first time, a message is received comprising a pseudo hardware address for a client wireless device associated with the client. The pseudo hardware address is assigned to the client wireless device. The client wireless device is paired with a wireless device associated with the user. A message is generated comprising pairing information for a pairing between the client wireless device and the user wireless device and the pairing information is sent to the server for storage. When the user subsequently logs on, a message is received comprising the pairing information and the client wireless device is provisioned with the pairing information.

### TECHNICAL FIELD

The present disclosure relates to Bluetooth headset and client host pairing in a hosted desktop environment for Unified Communications (UC).

### BACKGROUND

The field of UC is a growing technology that unifies various forms of human communication via a device into a common user experience. UC may integrate real-time communications services such as instant messaging and presence, telephony, and video conferencing with other communications services such as voicemail, email, facsimile, and short messaging services. UC also attempts to achieve media independence. For example, an individual may be in a meeting and receive a call that cannot be accepted during the meeting. Sometime later, a voicemail notification is received for a voicemail which also may not be retrievable by a phone call without disrupting the meeting. UC techniques allow the individual to receive a text version of the voicemail on a handheld device that was converted to text by a voice recognition tool. In this way, UC can increase human productivity by reducing human communications latency.

UC may be virtualized. That is, the UC application may run in a hosted virtual desktop server (HVDS) while the user interface for the application is displayed on a remote virtual desktop thin client (VDTC). Virtualized UC presents a set of unique problems in that the media may be more difficult to virtualize than simple text and graphics. In some environments a user may employ a headset device that operates with the short-range wireless technology known commercially as Bluetooth® (hereinafter Bluetooth (BT)), to make and answer telephone calls. In a call center environment the BT user may wish to roam from one thin client device to another, e.g., between BT audio hosts that are also referred to as audio gateways. However, each time a user roams, the user needs to initiate a pairing procedure between the headset and connection point that is time consuming and error prone.

### BRIEF DESCRIPTION OF THE DRAWINGS

FIG. 1 is an example of a block diagram showing a UC environment in which BT headset and BT client device pairing information is stored on an HVDS.

FIG. 2 is an example of a block diagram showing the UC environment in which a user with the BT headset roams from a first VDTC to a second VDTC, and the BT headset is automatically connected at the second VDTC.

FIG. 3 is an example of a block diagram of a HVDS device that is configured to store and retrieve pairing information using a UC control agent wireless device pre-connection process.

FIG. 4 is an example of a block diagram of a VDTC device that is configured to generate pairing information and provision a BT client with previously stored pairing information using a UC client wireless device pre-connection process.

FIGS. 5a and 5b illustrate an example of a flow chart generally depicting operations of the UC control agent wireless device pre-connection process at an HVDS.

FIGS. 6a and 6b illustrate an example of a flow generally depicting operations of the UC client wireless device pre-connection process at a VDTC for two different login scenarios.

### DESCRIPTION OF EXAMPLE EMBODIMENTS

### Overview

Techniques are provided to enable roaming of short-range wireless devices in a desktop computing environment. A desktop thin client device sends a message to a hosted desktop server, the message comprising information configured to indicate that a user has logged on to the desktop thin client device. A determination is made as to whether the user is logging on for a first time. When the user logs on for the first time, a message is received comprising a pseudo hardware address for a client wireless device associated with the desktop thin client device. The pseudo hardware address is assigned to the client wireless device. The client wireless device is paired with a user wireless device associated with the user using the pseudo hardware address. A message is generated comprising pairing information for a pairing between the client wireless device and the user wireless device and the pairing information is sent to the hosted desktop server for storage. When the user logs on for a subsequent time, a message is received comprising the pairing information and the pseudo hardware address, and the client wireless device is provisioned with the pairing information, where the client wireless device is configured to automatically connect with the user wireless device without pairing when the corresponding client wireless device is provisioned with the pairing information and the pseudo hardware address. Techniques are also provided herein for complementary functions at the hosted desktop server.

### Example Embodiments

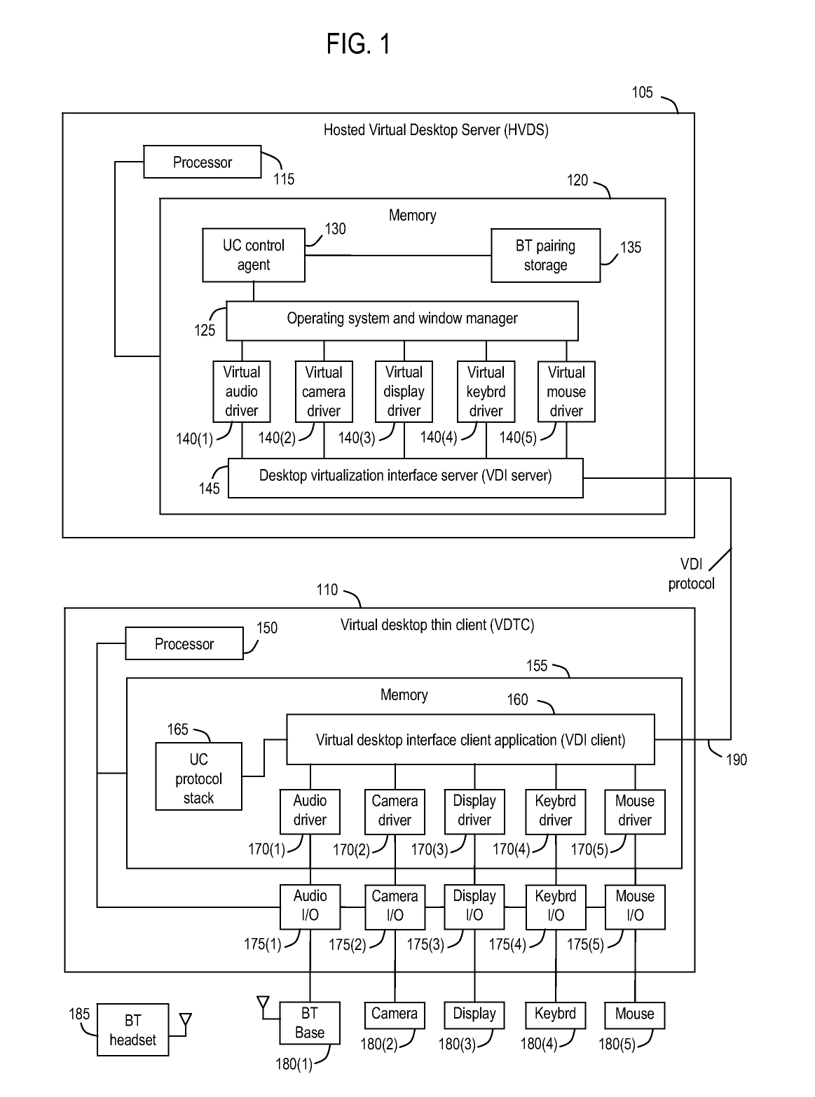

Referring first to FIG. 1, an example of a block diagram is shown for a virtualized desktop environment in which Bluetooth (BT) headset and BT client device pairing information is stored on a hosted virtual desktop server (HVDS). The environment has an HVDS 105 and a virtual desktop thin client (VDTC) 110. The HVDS 105 has a processor 115 and a memory 120. Resident in memory 120 are an operating system and window manager 125, and a UC control agent 130. The operating system and window manager 125 interfaces with virtual audio, camera, display, keyboard, and mouse drivers 140(1)-140(5), respectively, which in turn, interface to a virtual desktop infrastructure server (VDI server) 145.

The VDTC 110 has a processor 115 and a memory 120. Resident in memory 120 are a virtual desktop interface client application (VDI client) 160, a UC protocol stack 165, and audio, camera, display, keyboard, and mouse drivers 170(1)-170(5), respectively. Drivers 170(1)-170(5) drive audio, camera, display, keyboard, and mouse input-output (I/O) components 175(1)-175(5), respectively. I/O components 175(1)-175(5) interface with a BT wireless base (audio), camera, display, keyboard, and mouse devices 180(1)-180(5), respectively. Virtual drivers 140, VDTC drivers 170, and I/O devices 175 are examples; other sets of drivers and I/O devices may also be included. Thus, VDTC 110 has one or more I/O interfaces configured to support UC sessions. Audio is exchanged between BT base device 180(1), e.g., a BT adapter, and a BT headset 185. The virtual desktop thin client 110 and the virtual desktop server 105 are coupled by Virtual Desktop Interface (VDI) protocol link 190.

In this example, VDTC 110 is associated with a user wearing the BT headset 185. Any applications that the user may be interacting with are hosted by HVDS 105, e.g., as a virtual machine running on a hypervisor, while the user interface, e.g., a graphical user interface (GUI), associated with the application is rendered on VDTC client 110. For example, as the user types on keyboard 180(4) or exercises mouse 180(5), those inputs are translated by VDI client 160 and sent to the VDI server 145 via a VDI link 190, as shown. The VDI server 145, in turn, translates the VDI information into virtual keyboard and mouse inputs by way of virtual keyboard driver 140(4) and virtual mouse driver 140(5). The virtual keyboard and mouse inputs are fed to UC control agent 130 or other applications 135 as if the applications and the I/O devices 180 were running on a single desktop computing device.

All BT devices are associated with a driving application. The application may be as simple as a phone application or more complicated in the case of a video teleconference application that may include voice, video, whiteboards, and presentation features. As the user interacts with the application, the virtual keyboard and mouse inputs are processed by the application and GUI information is generated by the operating system and window manager 125 for transmission back to virtual desktop thin client 110. The virtual desktop thin client 110 renders the GUI for display to the user on display 180(3). Audio and video I/O, e.g., voice inputs to BT wireless base device 180(1) and image inputs to camera 180(2) may be processed in a similar fashion.

The audio and video associated with a UC session or teleconferencing application are not so easily processed by the VDI methods described above. There are several reasons for this. First, use of the VDI protocol to transport audio and video may consume much more network bandwidth since the audio and video media will need to be transmitted in a relatively uncompressed form over the VDI protocol, rather than using UC voice and video codecs and the Real-time Transport Protocol (RTP) to transport the media directly from the VDTC to a far-end party. Second, redirection of all RTP data to a centralized location where the HVDSs for all VDTCs are present will needlessly concentrate bandwidth at the centralized location. Third, if RTP is coded and decoded on the HVDS, its compute load is much higher than it needs to be, causing scalability problems on the HVDS devices. For this reason, UC audio and video are transported via RTP streams directly to and from another party, e.g., as part of a video teleconference, under the control of UC protocol stack 165. Different network paths may be used for VDI communication, call signaling, and media transmission. Operations of a video teleconference may be controlled or administered by UC control agent 130, e.g., Cisco Systems' Cisco Unified Personal Communicator (CUPC) or similar applications.

To participate in a phone call or a teleconference, the user will log on to the system via VDTC 110 and be authenticated by the HVDS 105. After login, the user needs to pair the BT headset 185 with a corresponding BT host via the BT base device 180(1), and a communication protocol stack is maintained by way of UC protocol stack 165. To start the pairing process, BT devices may be configured in a “discoverable” mode by which a BT device may be discovered by other BT devices. If configured for mutual communication, both BT devices will share their hardware addresses and an encryption key. The hardware addresses are known as the BD_ADDR in BT parlance, which is similar to a Media Access Control (MAC) address. For complex devices both BT devices agree on a passkey, which may be any code but is usually four digits, e.g., “1234”. Simple devices such as a BT headset, e.g., BT headset 185, may have a factory default passkey, e.g., “0000”. To complete the pairing, the user would enter the passkey onto an application running on the VDTC 110, e.g., using keyboard 180(4). After pairing is complete, BT communications can commence.

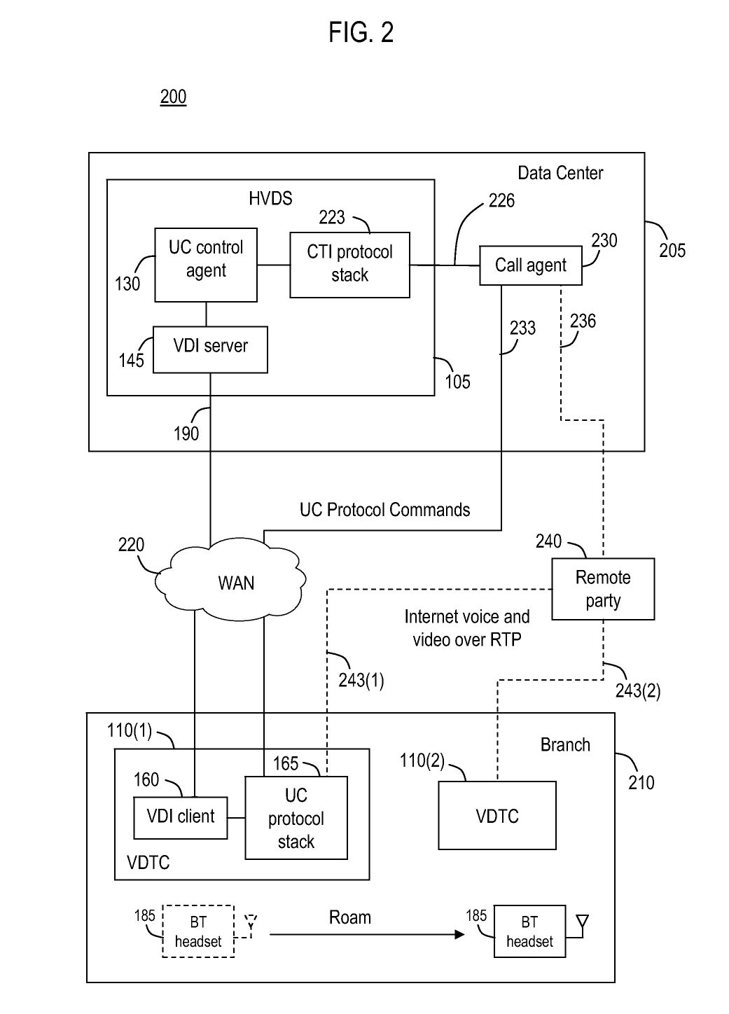

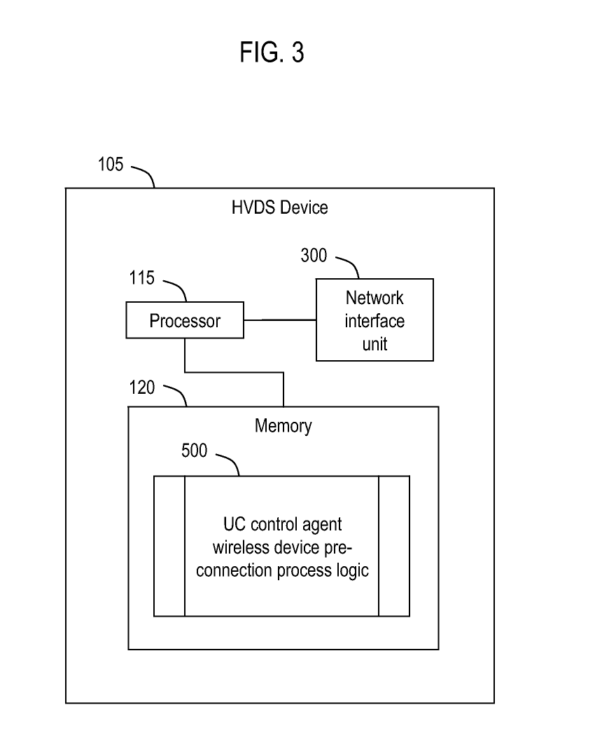

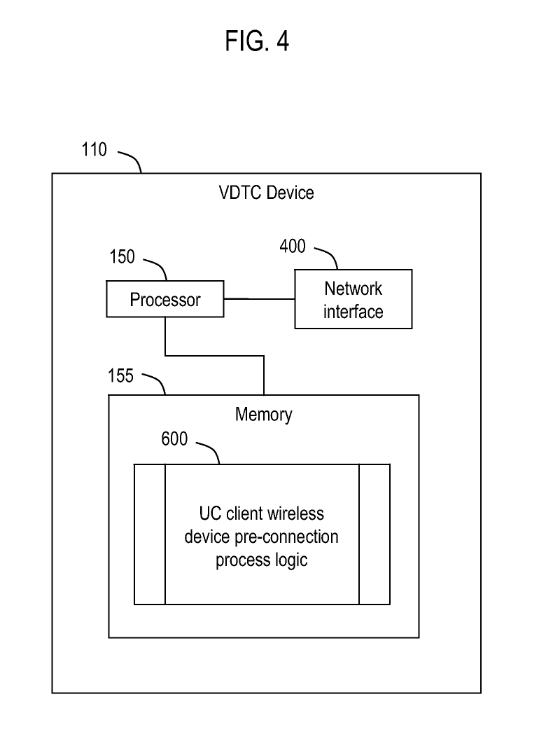

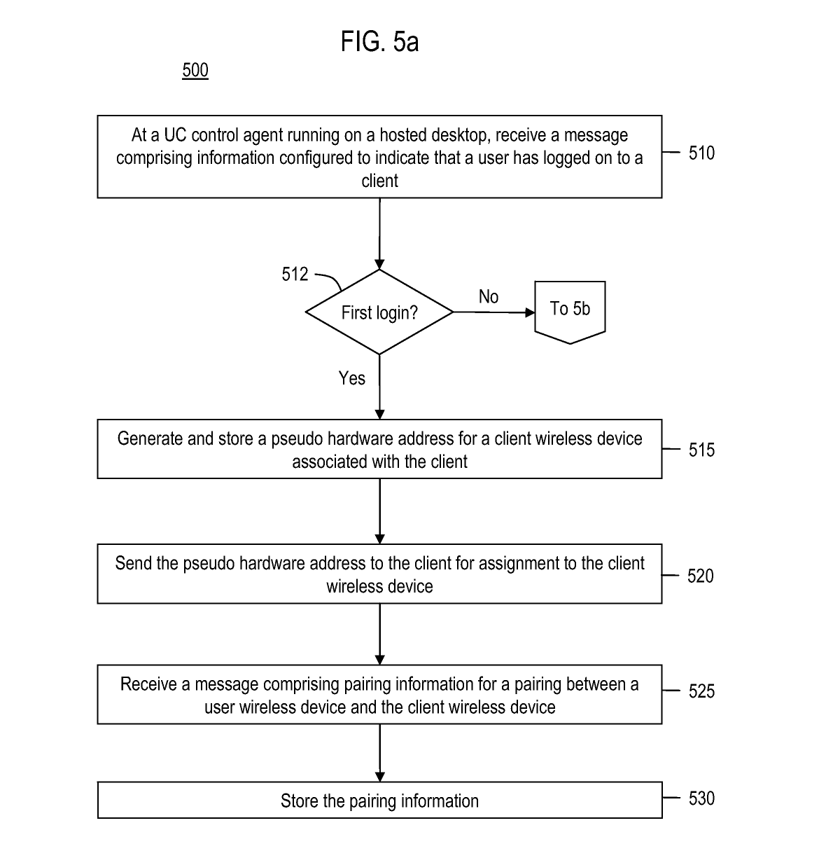

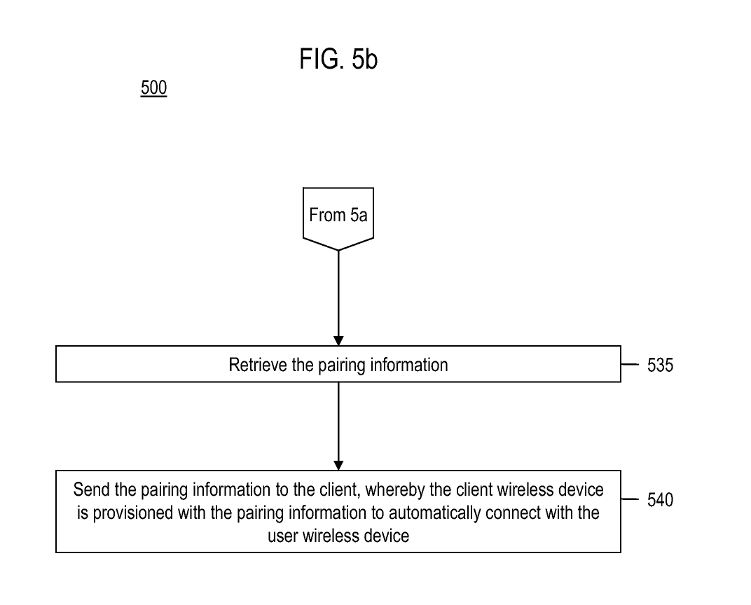

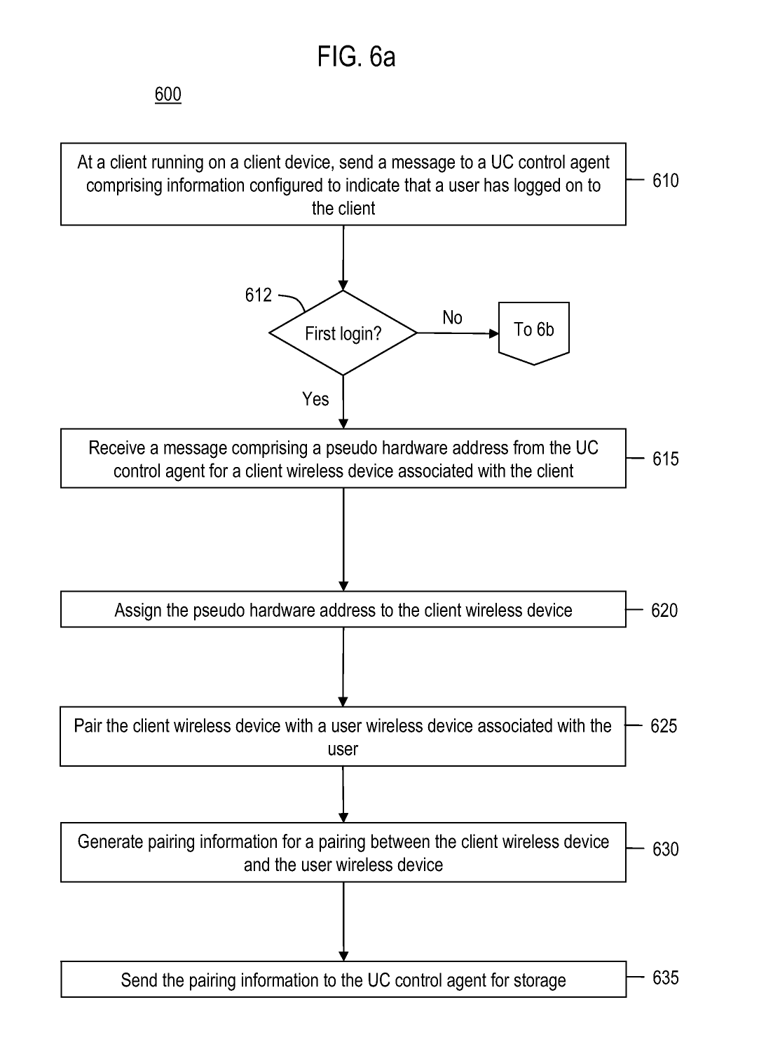

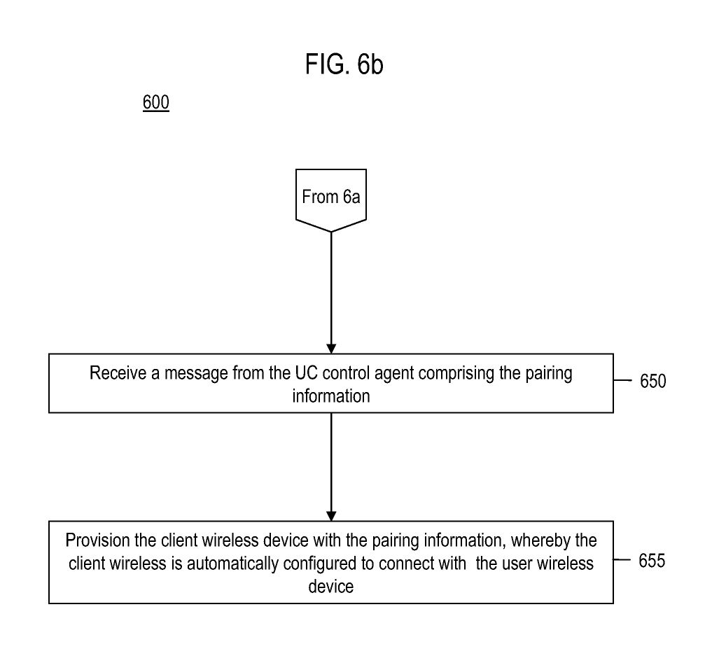

When a user is in a call center or data center, the user may “roam” or move from workstation to workstation. Each time the user roams, the user needs to log into the new workstation and pair the BT headset with the host; a time consuming and error prone process. Alternatively, each workstation may be equipped with its own BT headset that is paired with the BT client, but the headset needs to be adjusted for each individual's comfort. However, for both sanitary and user comfort reasons, each user prefers to have a personal BT headset. The techniques described herein provide a mechanism for user roaming without a pairing operation by using a pairing information storage and retrieval process, hereinafter the “wireless device pre-connection process logic.” Operation of the wireless device pre-connection process logic will be generally described in connection with FIG. 2. Operation of the wireless device pre-connection process logic will be described with respect to an HVDS device in connection with FIGS. 3, 5a and 5b, while operation of the wireless device pre-connection process logic with respect to a VDTC device will be described in connection with FIGS. 4, 6a, and 6b.

Referring to FIG. 2, a system 200 is shown in which HVDS 105 is stationed in a data center 205 and VDTCs 110(1) and 110(2) are stationed in a branch office 210. The data center 205 and the branch office 210 communicate through Wide Area Network (WAN) 220. In addition to some of the components from FIG. 1, the data center 205 has a call agent 230. Other components, e.g., Public Switched Telephone Network (PSTN) gateways are not shown. A remote party 240 is shown that may establish UC session, e.g., a teleconference with a party or user associated with VDTC 110. It is to be appreciated that many other networking components, e.g., routers and switches, may be used in system 200.

The remote party 240 may send and receive RTP voice and video directly with the VDTC 110(1) over link 243(1) or directly with the VDTC 110(2) over link 243(2). Remote party 240 may be located anywhere, e.g., within a main office, branch office, or external to both. If the remote party's RTP flows through the WAN link 220, a failure will destroy the UC media session. Call signaling for UC sessions between the VDTCs and remote parties is made via link 233.

In this example, the BT headset 185 is initially associated with VDTC 110(1) and the VDI server 145 and VDI client 160 are in normal communication via VDI link 190 by way of WAN 220. The UC control agent 130 controls an audio or audio/video call between the user in branch 210 and remote party 240. The UC control agent 130 sends third-party call control signals, e.g., Computer Telephony Integration (CTI) signals (as a CTI master) via the CTI protocol stack 223 to call agent 230 over link 226 for controlling the media portion of the teleconference, while the application specific information and GUI information are communicated between VDI server 145 and VDI client 160 via VDI link 190. The call agent 230 sends UC protocol commands based on the CTI signals to UC protocol stack 165 over link 233, e.g., signals associated with call set up, tear down, or mid-call control. Corresponding call signaling is sent to remote party 240 via link 236. Once a teleconference is set up, Internet voice and video may be exchanged between the virtual desktop thin client 110(1) and 110(2) and the remote party 240 over links 243(1) and 243(2), respectively.

The establishment of an association between the UC protocol stack and the call agent 230 is known to as “registration”. Such registration can take many forms and should not be construed as requiring any specific form of connection establishment or endpoint identification. In this example, it can be assumed that the VDI client 160 is online and coupled to display, keyboard, and mouse devices, for user interaction with UC control agent 130 and the UC protocol stack 165 is coupled to display, camera, and audio devices for communicating media information, i.e., inbound video for display, inbound and outbound audio for BT headset 185, and outbound video from a camera. The UC protocol stack 165 may also be referred to as a UC client software stack, e.g., a Client Services Framework (CSF) stack. In this example, UC control agent 130 uses CTI signals via call agent 230 to control the UC protocol stack 165 on VDTC 110 via link 233. In another example, UC control agent 130 may send remote procedure calls (RPCs) to UC protocol stack 165, via a pathway that is not shown in the figure.

The user associated with BT headset 185 has roamed from VDTC 110(1) to VDTC 110(2). In conventional BT systems, the user would log off of VDTC 110(1) and log on to VDTC 110(2). After log off from VDTC 110(1), the UC protocol stack 165, CTI protocol stack 223, and other resources system 200 associated with the user are returned to their respective entities. In other words, UC protocol stack 165 is unregistered and the associated resources are freed. The user would then log on to VDTC 110(2) and pair the BT headset 185. If the procedure is not followed properly, e.g., a user fails to log off before roaming or un-pair the BT headset, the BT endpoints may get confused, or reconnect if the BT headset remains within range of the originally paired endpoint. Note that either the BT headset or the BT endpoint/host can initiate reconnection.

To avoid these and other issues that occur due to BT user device roaming, user specific pairing information is stored on the HVDS, e.g., HVDS 105. For example, when a user logs onto the VDTC, wireless device pre-connection process logic within both the VDTS and the HVDS cooperate to preserve the user specific information. Briefly, on the HVDS side and after the user first logs on to the system, the HVD agent, e.g., UC control agent 130, creates and stores a new pseudo BT MAC address. The pseudo BT MAC address is sent to the VDTC, e.g., VDTC 110(1), and placed on the UC protocol stack 165. The BT hardware associated with the VDTC, e.g., BT wireless base device 180(1), uses the pseudo BT MAC address as its MAC address.

On the VDTC side and after pairing with the BT headset, an encryption key for BT communication is generated as part of the BT pairing process and placed on the UC protocol stack 165. The VDI client, e.g., the VDI client 160, as part of the wireless device pre-connection process logic, retrieves the pseudo BT MAC address, the headset BT_ADDR, and the encryption key, and sends all three as pairing information to the UC control agent 130. The UC control agent 130 stores the pairing information in memory or some other data store. The UC control agent 130 knows that the pairing information is associated with a specific user and also may store a user identifier (UID) with the pairing information. When the user logs off of VDTC 110(1) the paring information is removed from the on the UC protocol stack 165 on VDTC 110(1), while the pairing information may be stored on the HVDS indefinitely.

Once the pairing information is stored at the HVDS, the HVDS 105 or any HVDS within data center 205, or system 200 may have access to the UID, pseudo BT MAC address, headset BT_ADDR, and the encryption key combination. When the BT headset 185 roams with the user, the pairing information may be used to reestablish BT communication without the repeating the pairing process with the new thin client. After the user roams from VDTC 110(1) and logs in to VDTC 110(2), the HVDS 105 retrieves the pseudo BT MAC address and the encryption key from the data store. The HVDS 105 may use the UID as a database lookup parameter. The HVDS 105 sends the pairing information to VDTC 110(2). VDTC 110(2) populates a corresponding BT protocol stack with the headset BT_ADDR and encryption key retrieved from the data store, and assigns the pseudo BD_ADDR to the client's BT base radio. Once the protocol stack is populated, the VDTC 110(2) is automatically configured for connectivity with BT headset 185 and communication can commence.

Turning to FIG. 3, an example block diagram of an HVDS device, e.g., HVDS device 105, is shown that is configured to provide BT pairing information storage and retrieval. HVDS device comprises processor 115, a network interface unit 300, and a memory 120. Other device components are not shown for simplicity. Resident in the memory 120 is software for UC control agent wireless (wireless) device pre-connection process logic 500, e.g., that may be performed by UC control agent 130 (FIGS. 1 and 2).

The data processing device 115 is, for example, a microprocessor, a microcontroller, systems on a chip (SOCs), or other fixed or programmable logic. The data processing device 115 is also referred to herein simply as a processor. The memory 120 may be any form of random access memory (RAM) or other tangible (non-transitory) memory media or storage device that stores data or instructions used for the techniques described herein. The memory 120 may be separate or part of the processor 115. Instructions for performing the process logic 500 may be stored in the memory 120 for execution by the processor 115 such that when executed by the processor, causes the processor to perform the operations describe herein in connection with FIG. 5. The network interface unit 300 enables network communication throughout system 200 shown in FIG. 2 and the associated components shown in FIG. 1.

The functions of the processor 115 may be implemented by a processor or computer readable tangible (non-transitory) medium encoded with instructions or by logic encoded in one or more tangible media (e.g., embedded logic such as an application specific integrated circuit (ASIC), digital signal processor (DSP) instructions, software that is executed by a processor, etc.), wherein the memory 120 stores data used for the computations or functions described herein (and/or to store software or processor instructions that are executed to carry out the computations or functions described herein). Alternatively, one or more tangible (non-transitory) computer readable storage media are provided and encoded with software comprising computer executable instructions and when the software is executed operable to performing the techniques described herein. Thus, functions of the process logic 500 may be implemented with fixed logic or programmable logic (e.g., software or computer instructions executed by a processor or field programmable gate array (FPGA)). Process logic 500 has been generally described above in connection with FIGS. 1 and 2, and will be described in additional detail hereinafter in connection with FIGS. 5a and 5b.

Referring to FIG. 4, an example block diagram of a VDTC device, e.g., VDTC device 110, is shown that is configured to generate BT pairing information for storage and retrieval. Virtual desktop thin client 110 comprises processor 150, a network interface unit 400, and a memory 155. The network interface unit 400 enables network communications in the system 200. Other device components are not shown for simplicity. Resident in the memory 120 is software for UC client wireless device pre-connection process logic 600, e.g., that may be performed by VDI client 160 (FIGS. 1 and 2). Process logic 600 has been generally described above in connection with FIGS. 1 and 2, and will be described in additional detail hereinafter in connection with FIGS. 6a and 6b. The data processing device 150, memory 155, and network interface 400 enables communication throughout system 200 shown in FIG. 2 and the associated components shown in FIG. 1. It should be understood that any of the devices in system 200 may be configured with a similar hardware or software configuration as devices 105 and 110.

Referring to FIGS. 5a and 5b, the UC control agent wireless device pre-connection process logic 500 will now be described. At 510, at a UC control agent running on a hosted desktop, a message is received that includes information configured to indicate that a user has logged on to a client. After login, the HVDS device is aware of the user profile and the associated applications available to the user included wireless applications including UC and BT applications. At 512, it is determined if the user is logging in to the system for the very first time. If so, at 515, a pseudo hardware address for a client wireless device, e.g., BT wireless device 180(1) (FIG. 1), associated with the client is generated and stored. The pseudo hardware address is generated only once for the initial login. Operations for subsequent logins will be described below. The pseudo hardware address may be in any form that allows the client wireless device to be identified via the wireless pathway and to be identified by the HVDS, e.g., a pseudo BT address or other unique ID. The client wireless device may be any wireless device that is coupled to a user based wireless device, e.g., BT headset 185.

At 520, the pseudo hardware address is sent to the client for assignment to the client wireless device. At 525, a message is received comprising pairing information for a pairing between a user wireless device and the client wireless device. The pairing information includes a device identifier for the client wireless device, e.g., a MAC address, the pseudo hardware address, or other unique identifier, as well as an encryption key if required. At 530, the pairing information is stored for use during subsequent logins. The pairing information may be stored in active RAM, non-volatile memory (NVM), or in a shared database.

If at 512, it is determined that the user has logged in to the system before, then process logic 500 continues on FIG. 5b. At 535, the pairing information is retrieved. At 540, the pairing information is sent to the client, and the pairing information is used to provision the client wireless device for automatic pairing with the user wireless device, i.e., once provisioned the client wireless device is configured to automatically connect with the user wireless device without pairing, e.g., BT headset 185.

Referring to FIGS. 6a and 6b, the UC client wireless device pre-connection process logic 600 for a VDTC will now be described. At 610, at a client, e.g., VDI client 160, running on a client device, a message is sent to a UC control agent comprising information configured to indicate that a user has logged on to the client. At 512, it is determined if the user is logging in to the system for the very first time. If so, the HVDS will generate a pseudo hardware address, e.g., a pseudo BD_ADDR address. At 615, a message is received comprising a pseudo hardware address from the UC control agent for a client wireless device associated with the client. At 620, the pseudo hardware address is assigned to the client wireless device. At 625, the client wireless device is paired with a user wireless device associated with the user, e.g., BT headset 185. At 630, pairing information is generated for a pairing between the client wireless device and the user wireless device, and at 635, the pairing information is sent to the UC control agent for storage. The pairing information will be used for subsequent user logins.

If at 612, it is determined that the user has logged in to the system before, then process logic 600 continues to FIG. 6b for subsequent user logins. At this point, since this login is a subsequent login, the HVDS retrieves the pairing information. At 650, a message is received from the UC control agent comprising pairing information. At 655, the client wireless device is provisioned using the pairing information and is configured to automatically connect with the user wireless device without pairing.

In sum, techniques are described herein for a client to send a message to a server comprising information configured to indicate that a user has logged on to the client. A determination is made as to whether the user is logging on for a first time. When the user logs on for the first time, a message is received comprising a pseudo hardware address for a client wireless device associated with the client. The pseudo hardware address is assigned to the client wireless device. The client wireless device is paired with a wireless device associated with the user. A message is generated comprising pairing information for a pairing between the client wireless device and the user wireless device and the pairing information is sent to the server for storage. When the user logs on for a subsequent time, a message is received comprising the pairing information and the client wireless device is provisioned with the pairing information, and the wireless device associated with the user is automatically paired with the client wireless device when provisioning is complete.

The received message may comprise one of a pseudo MAC address and a unique hardware identifier. The pairing information may comprise one or more of the pseudo hardware address, an encryption key, and a user identifier. The client and user wireless devices may communicate using the Bluetooth wireless communication protocol. The desktop thin client device and the server may be part of a UC system. In another example, the pairing information may be pre-provisioned on the server and sent to the client upon login, whereby the client wireless device can be automatically provisioned.

Techniques are also provided for a server device to receive a message comprising information configured to indicate that a user has logged on to a desktop thin client device. A determination is made as to whether the user is logging on for a first time. When the user logs on for the first time, a pseudo hardware address is generated and stored for a client wireless device associated with the desktop thin client device. The pseudo hardware address is sent to the desktop thin client device for assignment to the client wireless device. A message is received comprising pairing information for a pairing between a user wireless device and the client wireless device. The pairing information is stored. When the user logs on for a subsequent time, the pairing information is retrieved and sent to the desktop thin client device, and the client wireless device is automatically configured to connect with the user wireless device when the client wireless device is provisioned with the pairing information.

The above description is by way of example only.

What is claimed is:

1. A method comprising:
at a desktop thin client device, sending to a server a message comprising information configured to indicate that a user has logged on to the desktop thin client device;
determining if the user is logging on for a first time;
when the user logs on for the first time, receiving a message comprising a pseudo hardware address, wherein the pseudo hardware address is unique address associated with the user;
assigning the pseudo hardware address to a client wireless device associated with the desktop thin client device;
pairing the client wireless device with a user wireless device associated with the user using the pseudo hardware address;
generating pairing information for a pairing between the client wireless device and the user wireless device; and
sending the pairing information to the server for storage.

2. The method of claim 1, further comprising:
when the user logs on for a subsequent time at the desktop thin client device or another desktop thin client device, receiving at a desktop thin client device corresponding to the user logon a message comprising the pairing information and the pseudo hardware address; and
provisioning a corresponding client wireless device with the pairing information and pseudo hardware address, wherein the corresponding client wireless device is configured to automatically connect with the user wireless device without pairing when the corresponding client wireless device is provisioned with the pairing information and the pseudo hardware address.

3. The method of claim 1, wherein receiving comprises receiving the message comprising one or more of a hardware address of the user wireless device and an encryption key.

4. The method of claim 1, wherein generating comprises generating pairing information comprising one or more of a hardware address of the user wireless device, an encryption key, and a user identifier.

5. The method of claim 1, wherein the client wireless device and the user wireless device communicate using the Bluetooth® wireless protocol.

6. The method of claim 1, wherein the pairing information is pre-provisioned on the server and receiving comprises receiving the message comprising the pairing information after login without determining login order, and without generating and sending the pairing information, and further comprising provisioning the client wireless device with the pairing information.

7. A method comprising:
at a server device, receiving a message comprising information configured to indicate that a user has logged on to a desktop thin client device;
determining if the user is logging on for a first time;
when the user logs on for the first time, generating and storing a pseudo hardware address, wherein the pseudo hardware address is a unique address associated with the user;
sending the pseudo hardware address to the desktop thin client device for assignment to an associated client wireless device;
receiving a message comprising pairing information for a pairing between a user wireless device and the client wireless device; and
storing the pairing information with the pseudo hardware address.

8. The method of claim 7, further comprising:
when the user logs on a subsequent time at the desktop thin client device or another desktop thin client device, retrieving the pairing information and the pseudo hardware address; and
sending the pairing information and the pseudo hardware address to a desktop thin client device corresponding to the user logon, wherein the corresponding client wireless device is configured to automatically connect with the user wireless device without pairing when the corresponding client wireless device is provisioned with the pairing information and the pseudo hardware address.

9. The method of claim 7, wherein generating and storing comprises generating and storing the pseudo hardware address comprising one of an address in a format compatible with the Bluetooth® protocol and a unique hardware identifier.

10. The method of claim 7, wherein receiving comprises receiving the message comprising pairing information including one or more of a hardware address of the user wireless device and an encryption key.

11. An apparatus comprising:
a network interface device configured to send and receive over a network information associated with a desktop thin client;
a processor coupled to the network interface device and configured to:
send to a server a message comprising information configured to indicate that a user has logged on to the desktop thin client;
determine if the user is logging on for a first time;
when the user logs on for the first time, receive a message comprising a pseudo hardware address for a client wireless device associated with the desktop thin client;
assign the pseudo hardware address to the client wireless device;
pair the client wireless device with a user wireless device associated with the user using the pseudo hardware address;
generate pairing information for a pairing between the client wireless device and the user wireless device; and
send the pairing information to the server for storage.

12. The apparatus of claim 11, wherein the processor is further configured to:
when the user logs on a subsequent time, receive a message comprising the pairing information and the pseudo hardware address; and
provision the client wireless device with the pairing information and the pseudo hardware address, wherein the corresponding client wireless device is configured to automatically connect with the user wireless device without pairing when the corresponding client wireless device is provisioned with the pairing information and the pseudo hardware address.

13. The apparatus of claim 11, wherein the processor is configured to generate pairing information comprising one or more of a user wireless device hardware address, an encryption key, and a user identifier.

14. The apparatus of claim 13, wherein processor is further configured to communicate via the client wireless device using the Bluetooth® wireless protocol.

15. A system comprising the apparatus of claim 11, and further comprising the server, wherein the server is configured to:
receive the message comprising the information configured to indicate that a user has logged on to a desktop thin client;
determine if the user is logging on for a first time;
when the user logs on for the first time, generate and store the pseudo hardware address for the client wireless device;
send the pseudo hardware address to the desktop thin client for assignment to the client wireless device;
receive the pairing information; and
store the pairing information.

16. The system of claim 15, wherein the server is further configured to:
when the user logs on for a subsequent time, retrieve the pairing information; and
send the pairing information to the desktop thin client, wherein the client wireless device is configured to automatically connect with the user wireless device without pairing when the corresponding client wireless device is provisioned with the pairing information and the pseudo hardware address.

17. The system of claim 15, wherein the server is configured to generate and store the pseudo hardware address comprising one of a pseudo Bluetooth® hardware address and a unique hardware identifier.

18. One or more computer readable media encoded with instructions that, when executed by a processor, cause the processor to:
send to a server a message comprising information configured to indicate that a user has logged on to a desktop thin client;
determine if the user is logging on for a first time;
when the user logs on for the first time, receive a message comprising a pseudo hardware address for a client wireless device associated with the desktop thin client;
assign the pseudo hardware address to the client wireless device;
pair the client wireless device with a user wireless device associated with the user using the pseudo hardware address;
generate pairing information for a pairing between the client wireless device and the user wireless device; and
send the pairing information to the server for storage.

19. The computer readable media of claim 18, further comprising instructions that when executed cause the processor to:
when the user logs on for a subsequent time, receive a message comprising the pairing information and the pseudo hardware address; and
provision the client wireless device with the pairing information and the pseudo hardware address, wherein the client wireless device is configured to automatically connect with the user wireless device without pairing when the corresponding client wireless device is provisioned with the pairing information and the pseudo hardware address.

20. The computer readable media of claim 18, wherein the instructions that cause the processor to receive comprise instructions that when executed cause the processor to receive the message comprising one of a pseudo Bluetooth hardware address and a unique hardware identifier.

21. The computer readable media of claim 18, wherein the instructions that cause the processor to generate comprise instructions that when executed cause the processor to generate pairing information comprising one or more of a user wireless device hardware address, an encryption key, and a user identifier.

22. The computer readable media of claim 18, further comprising instructions that when executed cause the processor to communicate via the desktop thin client using the Bluetooth® wireless protocol.
